(19) United States
(12) Patent Application Publication
(10) Pub. No.: US 2026/0139699 A1
(43) Pub. Date: May 21, 2026

(54) STRUCTURAL OBJECT

(71) Applicant: KABUSHIKI KAISHA TOKAI RIKA DENKI SEISAKUSHO, Aichi (JP)

(72) Inventors: Yuta YAMANISHI, Aichi (JP); Yosuke HATADA, Aichi (JP); Keisuke TATEYAMA, Aichi (JP)

(73) Assignee: KABUSHIKI KAISHA TOKAI RIKA DENKI SEISAKUSHO, Aichi (JP)

(21) Appl. No.: 19/369,731

(22) Filed: Oct. 27, 2025

(30) Foreign Application Priority Data
Nov. 21, 2024 (JP) 2024-202869

(51) Int. Cl. F16B 9/00; B62D 1/16

(52) U.S. Cl. CPC F16B 9/07; B62D 1/16

(57) ABSTRACT

To implement a snap-fit mechanism that allows for easy disconnection. There is provided a structural object that is mounted on a mobile body, the structural object comprising: a first part; and a second part, wherein the first part and the second part are connected to each other using a snap-fit, any one of the first part or the second part includes a fulcrum section, any one of the first part or the second part includes a load section, and the structural object is formed to allow the first part and the second part to be disconnected by applying external force to a tool with part of the tool in contact with the fulcrum section and an end of the tool in contact with the load section.

### CROSS REFERENCE TO RELATED APPLICATION(S)

This application is based upon and claims benefit of priority from Japanese Patent Application No. 2024-202869, filed on Nov. 21, 2024, the entire contents of which are incorporated herein by reference.

### BACKGROUND

The present invention relates to a structural object.

For example, as disclosed in JP 2024-125272A, parts are connected using a snap-fit in a structural object mounted on a mobile body such as a vehicle in some cases.

### SUMMARY

The detachment (disconnection) of parts connected using a snap-fit typically depends on the experience, the know-how, and the like of an operator and is not excellent in efficiency.

Accordingly, the present invention has been devised in view of the problem. An object of the present invention is to implement a snap-fit mechanism that allows for easy disconnection.

To solve the above described problem, according to an aspect of the present invention, there is provided a structural object that is mounted on a mobile body, the structural object comprising: a first part; and a second part, wherein the first part and the second part are connected to each other using a snap-fit, any one of the first part or the second part includes a fulcrum section, any one of the first part or the second part includes a load section, and the structural object is formed to allow the first part and the second part to be disconnected by applying external force to a tool with part of the tool in contact with the fulcrum section and an end of the tool in contact with the load section.

As described above, the present invention makes it possible to implement a snap-fit mechanism that allows for easy disconnection.

### BRIEF DESCRIPTION OF THE DRAWINGS

FIG. 1 is a diagram for describing a configuration of a structural object 10 according to an embodiment of the present invention.

FIG. 2 is a diagram for describing the configuration of the structural object 10 according to the embodiment.

FIG. 3 is a diagram illustrating a configuration example of a connected section according to the embodiment illustrated by a chain line in FIG. 2.

FIG. 4 is a diagram for describing an operation at time of disconnection of a first part 110 and a second part 120 according to the embodiment.

### DETAILED DESCRIPTION OF THE EMBODIMENT(S)

Hereinafter, referring to the appended drawings, preferred embodiments of the present invention will be described in detail. It should be noted that, in this specification and the appended drawings, structural elements that have substantially the same function and structure are denoted with the same reference numerals, and repeated explanation thereof is omitted.

### 1. Embodiment

A structural object mounted on a mobile body includes a part group that is connected using a snap-fit in some cases to allow for detachment at the time of repairment or the like.

The snap-fit is a method for fixing parts by fitting the parts together using the elasticity of members. In addition, it is possible in many cases to disconnect the parts connected using a snap-fit by similarly using the elasticity of the members.

Most structural objects do not, however, include any mechanisms that assist in disconnection. The disconnection therefore depends on the experience, the know-how, and the like of an operator and is not excellent in working efficiency.

The technical idea according to an embodiment of the present invention has been conceived in view of the point as described above and implements a snap-fit mechanism that allows for easy disconnection.

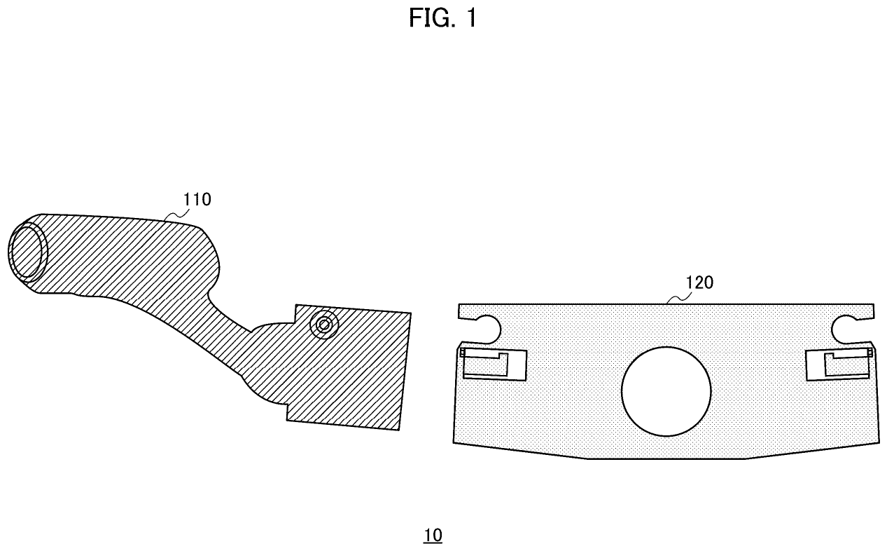

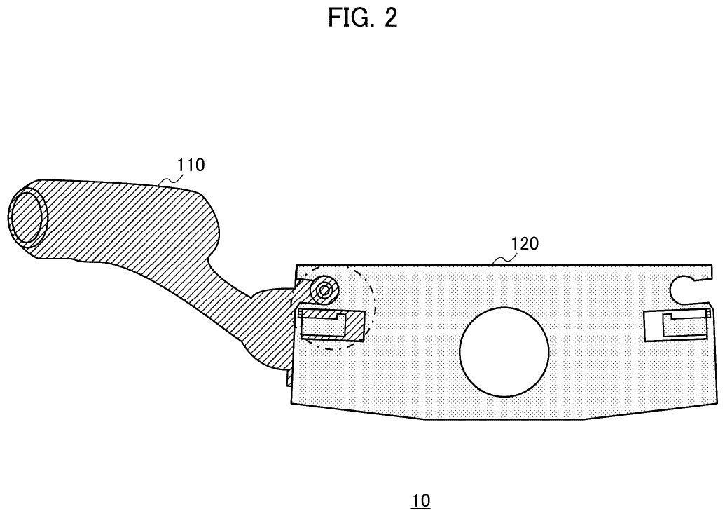

FIGS. 1 and 2 are diagrams for each describing the configuration of a structural object 10 according to an embodiment of the present invention.

The structural object 10 according to the present embodiment may be mounted on a mobile body.

The mobile body includes a vehicle, a vessel, an aircraft, and the like.

As illustrated in FIGS. 1 and 2, the structural object 10 according to the present embodiment includes a first part 110 and a second part 120.

The first part 110 and the second part 120 according to the present embodiment are connected to each other using a snap-fit.

FIG. 1 illustrates the first part 110 and the second part 120 that are not connected. In contrast, FIG. 2 illustrates the first part 110 and the second part 120 that are connected.

It should be noted that FIGS. 1 and 2 each illustrate the first part 110 in a diagonal stripe pattern and the second part 120 in a dot pattern to distinguish the first part 110 and the second part 120.

It is possible to reversibly switch the presence and absence of the connection of the first part 110 and the second part 120 according to the present embodiment.

The first part 110 may be, for example, a lever switch or the like. In addition, the second part 120 may be, for example, a steering column cover or the like.

The first part 110 and the second part 120 are disconnected, for example, in the case of the repairment, the inspection, or the like of a steering wheel, a steering column, a lever switch, and the like at the dealer.

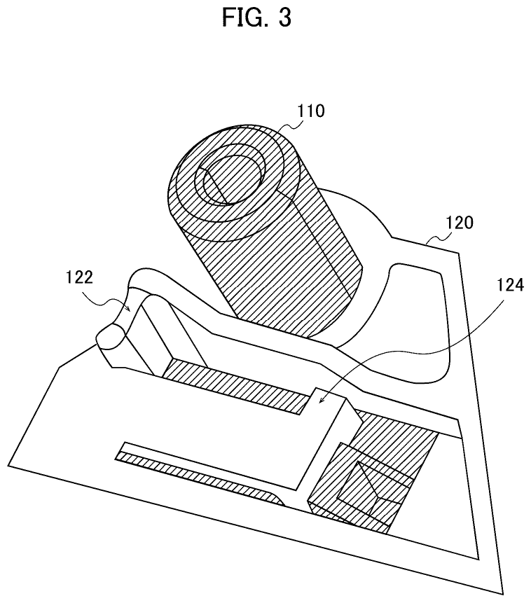

FIG. 3 is a diagram illustrating a configuration example of a connected section illustrated by the chain line in FIG. 2.

FIG. 3 illustrates the first part 110 in a diagonal stripe pattern and the second part 120 in solid color.

In the case of the example illustrated in FIG. 3, the second part 120 includes a fulcrum section 122 and a load section 124.

The fulcrum section 122 according to the present embodiment serves as the fulcrum of a lever when the first part 110 and the second part 120 are disconnected.

In addition, the load section 124 according to the present embodiment serves as the load of a lever when the first part 110 and the second part 120 are disconnected.

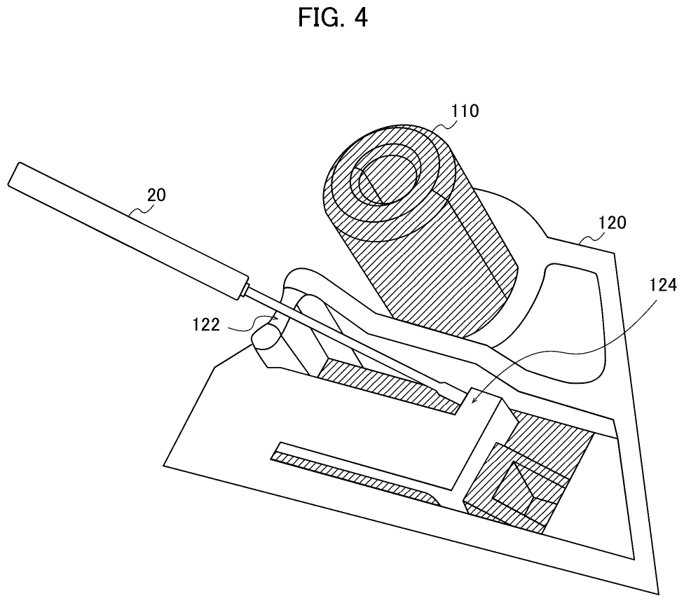

FIG. 4 is a diagram for describing an operation at the time of the disconnection of the first part 110 and the second part 120.

As illustrated in FIG. 4, an operator disconnects the first part 110 and the second part 120 by applying force to a tool 20 with part of the tool 20 in contact with the fulcrum section 122 (with the part of the tool 20 placed on the fulcrum section 122) and an end (point) of the tool 20 in contact with the load section 124.

More specifically, the operator may insert the point of the tool 20 under the load section 124 and push down a grip section provided on the opposite side to the point of the tool 20. This causes the point of the tool 20 to push up the load section 124 and the first part 110 and the second part 120 connected using a snap-fit are disconnected.

It should be noted that the fulcrum section 122 may have a round shape as illustrated in FIGS. 3 and 4 to facilitate the part of the tool 20 to be placed thereon. Alternatively, the fulcrum section 122 may have a recessed shape or the like for supporting the tool 20 more firmly.

In addition, the load section 124 may similarly include a mechanism for fixing the tool 20 more firmly.

In addition, the tool 20 may be, for example, an instrument such as a driver.

The configuration example of the structural object 10 according the present embodiment has been described so far. According to the configuration as described above, it is possible to implement a snap-fit mechanism that allows for easy disconnection.

The configuration described above is, however, merely an example. The configuration of the structural object 10 according to the present embodiment is not limited to the example.

For example, the above exemplifies a case where the grip section of the tool 20 serves as an effort, but the effort is not limited to the example. An operator may push up the tool 20, for example, near the load section 124. In this case, the section near the load section 124 serves as an effort.

In addition, for example, FIGS. 3 and 4 each exemplify a case where the load section 124 is pushed up to disconnect the first part 110 and the second part 120, but it is also possible to adopt a configuration in which the load section 124 is pushed down to disconnect the first part 110 and the second part 120.

In addition, for example, FIGS. 3 and 4 each exemplify a case where the fulcrum section 122 and the load section 124 are provided to the second part 120, but it is sufficient if the fulcrum section 122 and the load section 124 are provided to any one of the first part 110 or the second part 120. The fulcrum section 122 and the load section 124 do not have to be provided to the same part.

It is possible to flexibly modify the configuration of the structural object 10 according to the present embodiment depending on the specifications and the like.

### 2. Supplement

Heretofore, preferred embodiments of the present invention have been described in detail with reference to the appended drawings, but the present invention is not limited thereto. It should be understood by those skilled in the art that various changes and alterations may be made without departing from the spirit and scope of the appended claims.

What is claimed is:

1. A structural object that is mounted on a mobile body, the structural object comprising:
a first part; and
a second part, wherein
the first part and the second part are connected to each other using a snap-fit,
any one of the first part or the second part includes a fulcrum section,
any one of the first part or the second part includes a load section, and
the structural object is formed to allow the first part and the second part to be disconnected by applying external force to a tool with part of the tool in contact with the fulcrum section and an end of the tool in contact with the load section.

2. The structural object according to claim 1, wherein any one of the first part or the second part is a lever.

3. The structural object according to claim 1, wherein the tool is a driver.
